(19) United States
(12) Patent Application Publication
(10) Pub. No.: US 2002/0029223 A1
(43) Pub. Date: Mar. 7, 2002

(54) Prescription network supporting doctors, care givers and online drug store interaction

(76) Inventors: Marion R. Rice, Rochelle, TX (US); Bindu R. Rao, Austin, TX (US)

Correspondence Address: CHRISTOPHER C. WINSLADE, 2135 N. CLIFTON AVENUE, CHICAGO, IL, 60614, US

(21) Appl. No.: 09/799,363

(22) Filed: Mar. 5, 2001

Related U.S. Application Data
(60) Provisional application No. 60/185,984, filed on Mar. 8, 2000.

(51) Int. Cl. G06F 17/30

(52) U.S. Cl. 707/104.1; 707/200

(57) ABSTRACT

A prescription network is disclosed that enables a physician to remotely, for example, access a patient database via a first computer to review patient information and prescribe drugs for the patient. A drug analysis engine may also be included that, based on an evaluation of the patient information and a new prescription selected by the physician, displays one or more warnings, such as, for example, a drug interaction warning, on the first computer for consideration by the physician. The physician may authenticate a selected prescription using a digital signature, and store the prescription in the patient database. A healthcare provider, such as a nurse, for example, or the patient may then access the patient database via a second computer, which again may be remote from the patient database, to review the patient information and obtain the prescription. The prescription may then be filled by simply printing it and hand carrying it to a pharmacy, or by ordering the prescription online via the second computer.

### CROSS-REFERENCE TO RELATED APPLICATIONS

This application makes reference to, and claims priority to and the benefit of, U.S. provisional application Serial No. 60/185,985 filed Mar. 8, 2000.

### INCORPORATION BY REFERENCE

U.S. provisional application Serial No. 60/185,985 filed Mar. 8, 2000 is hereby incorporated by reference herein in its entirety.

### STATEMENT REGARDING FEDERALLY SPONSORED RESEARCH

NA

### BACKGROUND OF THE INVENTION

1. Technical Field

The present invention relates generally to ordering prescription drugs, and more specifically to a prescription drug network supporting online purchase of prescription drugs by patients from one or more online prescription drug vendors under the supervision and oversight of doctors and nurses.

2. Related Art

The prescription drug sale industry, although computerized in the last decade, is still dependent upon verification of the authenticity of prescriptions by means of telephone calls to the hospital or health care facility. In addition, there is no easy way for doctors and nurses to receive information regarding potential drug interaction problems as they prescribe drugs to patients who already possess and are consuming other prescription or non-prescription medication.

### SUMMARY OF THE INVENTION

Aspects of the present invention may be found in a prescription network that comprises a patient database that stores patient information. A web server is communicatively coupled to the patient database and to a physician computer. The physician computer runs browser software used by the physician to review the patient information. The web server delivers to the physician computer at least one web page that presents the patient information for review by the physician. The physician may, via input to the physician computer, generate a new prescription (or a refill of an old prescription) for the patient and store the prescription in the patient database as patient information.

In one embodiment, the physician web page presents a prescription interface that has a write prescription window. The physician may then manually complete the prescription window to generate the prescription. In another embodiment, the prescription window, in response to selection by the physician of the desired prescription, is automatically completed from information stored in a database. In addition, at the physician's request, a digital signature may be associated with the prescription, in which case both the prescription and the associated digital signature are stored in the patient database. The physician computer may also, when the physician selects the desired prescription, display alternate drug information for the physician to review an consider.

A user, such as a healthcare professional (e.g., nurse) or the patient, may then communicatively couple to the web server using a user computer, which runs browser software used by the user to review the patient information. The web server delivers at least one web page to the user computer that presents an indication of the prescription to the user. The user may, via the user computer, print the new prescription and hand carry the prescription to a pharmacy to get the prescription filled, or may order the prescription online via the web page delivered by the web server to the user computer.

In one embodiment, when the prescription is ordered online, the user computer automatically communicates an authorization for reimbursement of the user for the prescription ordered.

In one embodiment of the prescription network, the web server is positioned at a location remote from both the physician computer and the user computer. For example, the web server may be located at a healthcare agency, while the physician computer may be located at the physician's home (or office) and the user computer may be located at the patient's home or at a hospital. Of course other combinations are contemplated.

The prescription network may also comprise a drug analysis engine that evaluates the patient information and the prescription selected by the physician, and generates a warning based on the evaluation for display on one or both of the physician computer and the user computer. For example, the patient information may comprise current drug usage information (e.g., the drugs currently being taken by the patient). In that case, the drug analysis engine evaluates the drugs currently being taken by the patient in conjunction with the selected new prescription to determine if any potential drug interactions. This may be done using a cross-reference library in a drug interaction database. If a potential drug interaction is identified, a drug interaction warning may be generated for display on one or both of the physician computer and the user computer.

The patient database may also contain the patient's physiological information. In that case, the drug analysis engine evaluates the physiological information (e.g., high blood pressure, high cholesterol, etc.) and the new prescription to determine if any potential adverse reactions may occur as a result of the new prescription. This may also be done using a cross-reference library in a drug interaction database. If a potential adverse reaction is identified, a warning is generated and displayed on one or both of the physician computer and the user computer.

Of course, many variations, further detail and further aspects of the present invention may be found with reference to the detailed description that follows.

### BRIEF DESCRIPTION OF THE DIAGRAMS

The numerous advantages of the present invention may be better understood by those of skill in the art by reference to the accompanying figures in which:

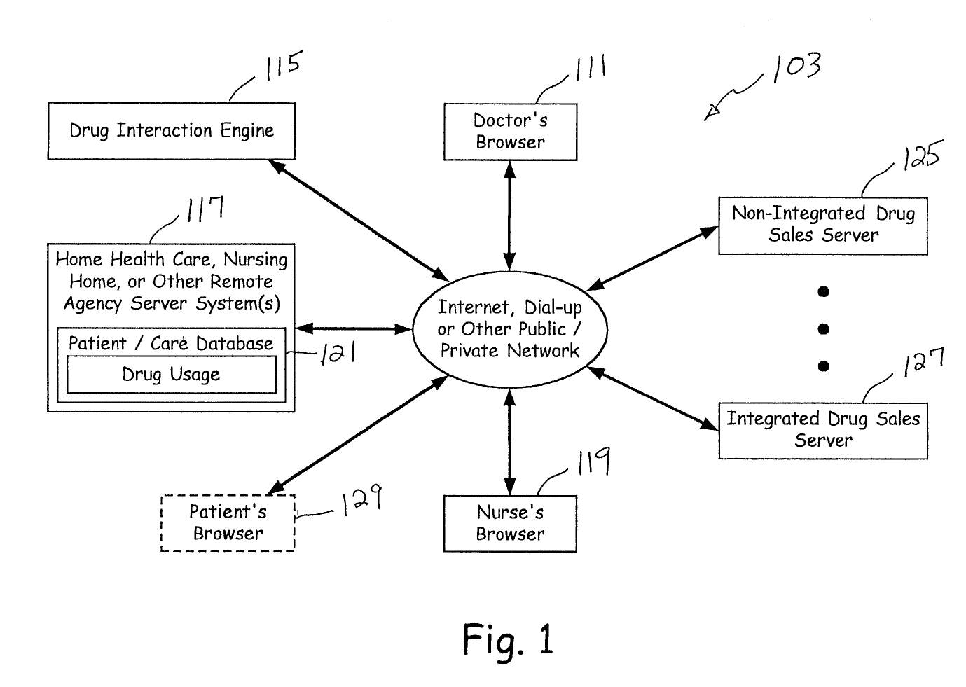

FIG. 1 is a perspective diagram of a prescription network that facilitates online purchase of prescription drugs from both integrated and non-integrated online drug sale servers under the watchful eyes of doctors and care providers involved in the prescription of the drugs and the delivery/administering of the drugs, respectively;

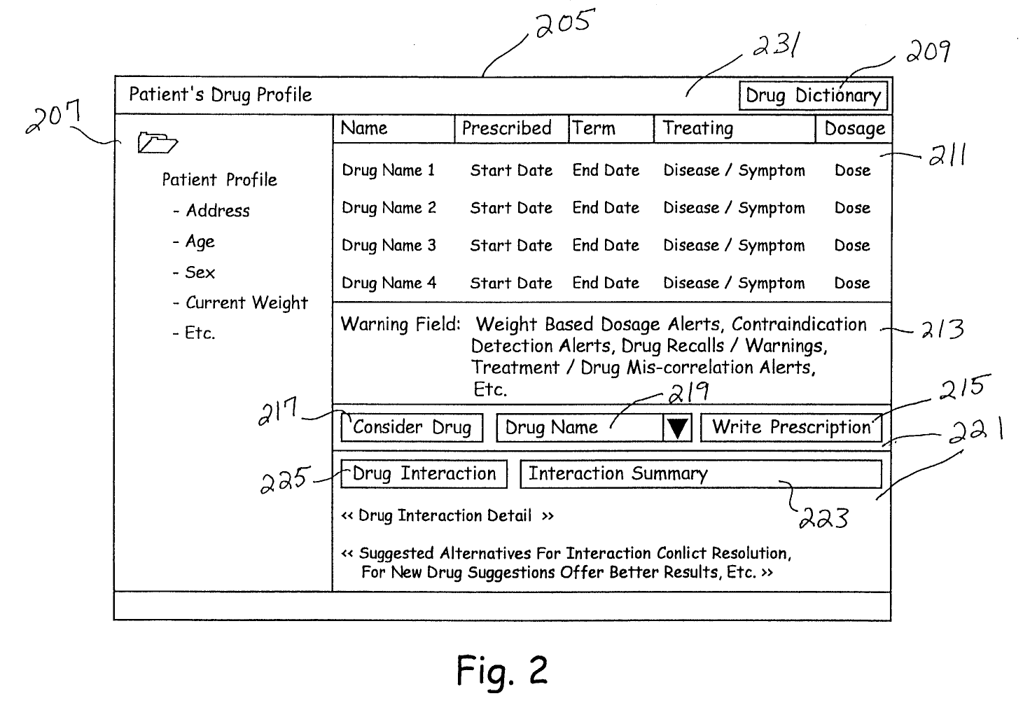

FIG. 2 is a perspective diagram illustrating a Patient's Drug Profile window that a doctor uses to review drug interaction information for a patient before prescribing any new prescription or non-prescription drugs;

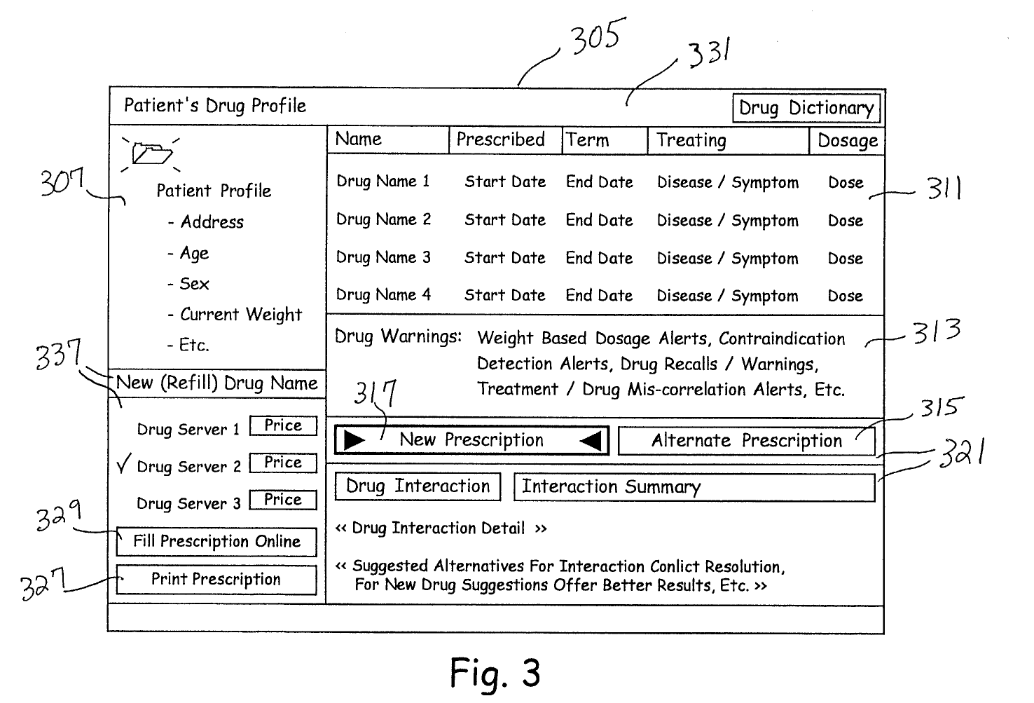

FIG. 3 is a perspective diagram that shows a Patient's Drug Profile window that a health care provider uses to review drug interaction information for a patient before prescribing any new prescription or non-prescription drugs, and to renew/refill/print out prescriptions.

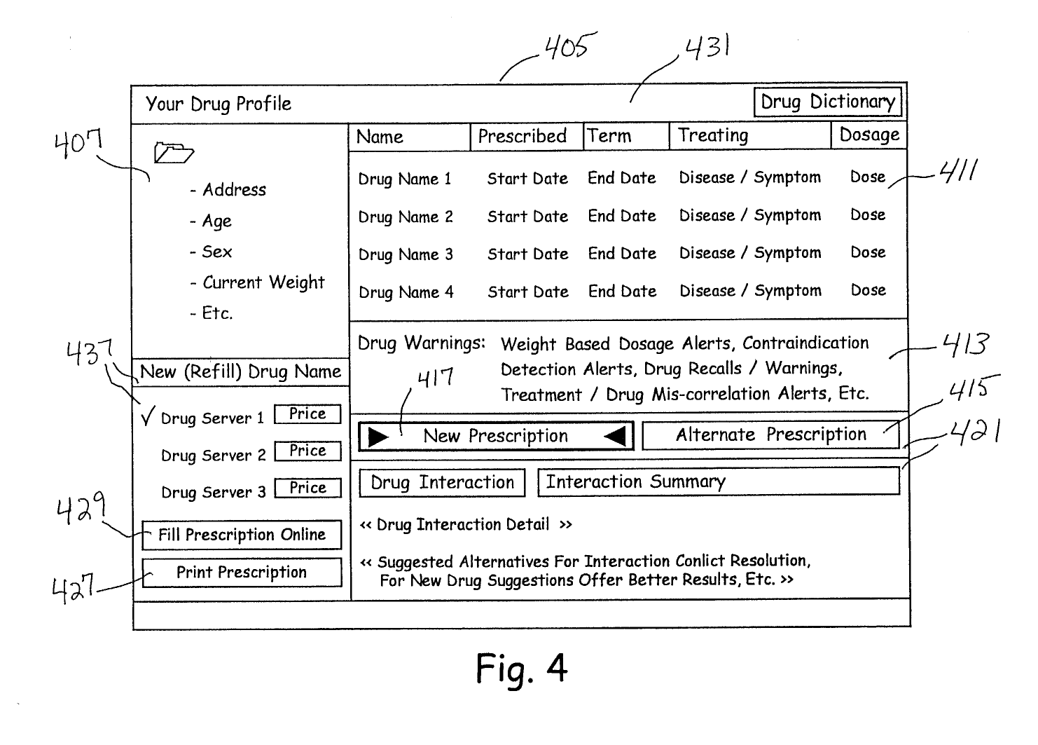

FIG. 4 is a perspective diagram that shows a Patient's Drug Profile window that a patient uses to review prescription drug information, drug interaction information and drug purchase information.

### DETAILED DESCRIPTION OF THE DIAGRAMS

FIG. 1 is a perspective diagram of a prescription network 103 that facilitates online purchase of prescription drugs from both integrated 127 and non-integrated 125 online drug sale servers, under the watchful eyes of doctor's and care providers involved in the prescription of the drugs and the delivery/administering of the drugs, respectively. Typically, a first doctor prescribes prescription drugs and/or non-prescription drugs for a patient online using his first doctor's browser 111, and the prescription is saved by a home health care, nursing home, or other remote agency server system(s) 117 in its patient care database 121. The patient care database 121 also stores information on usage of other drugs by the patient in its database.

A care provider or a doctor reviews or monitors a patient's drug usage information using the care provider browser 119 or the first doctor's browser 111, respectively. Such review may be conducted while prescribing new non-prescription or prescription drugs for the patient. Both doctors and nurses selectively review drug interaction information, using their browsers, while prescribing drugs to patients. The drug interaction information is automatically provided by a drug interaction engine 115, which may be located in the home health care, nursing home or other remote agency server system(s) 117.

Drugs for prescriptions may be purchased online by patients, and the purchased drugs may be delivered by the online integrated drug sales server 127 or the non-integrated drug sales server 125 directly to the patient or indirectly to the patient via the care provider, respectively.

Purchase of prescription or non-prescription drugs from the non-integrated drug sales server 125 requires verification of the authenticity of the prescription before delivery of drugs. Such verification may be achieved by calling or otherwise contacting the doctor or nurse and establishing the authenticity of the prescription. Purchase of prescription or non-prescription drugs from the integrated drug sales server 127 does not require calling or otherwise contacting the doctor or nurse to establish the authenticity of the prescription. Instead, the digital signature of the doctor, associated with a doctor's prescription, is transferred to the integrated drug sales server 127 for authentication purposes. The purchase is thus completed online without resorting to phone calls or other manual activities.

In one embodiment of the present invention, drugs purchased online are delivered by home health care providers to patients, and the home health care agency reimburses the online integrated 127 or non-integrated 125 drug sales server company for the drugs delivered directly or indirectly to the patient, as the case may be.

The patient's drug usage 121 information is accessible by the patient (via, e.g., patient's browser 129), by the patient's doctor(s), and by the doctor's nurses. A second doctor, who is perhaps a member of the first doctor's practice, may view a patient's drug usage information or prescription information. The patient care database 121 may be located in one of several places—at a doctor's office, at the home health care agency or nursing home 117 or at the non-integrated 125 or integrated drug sales server 127.

FIG. 2 is a perspective diagram illustrating a Patient's Drug Profile window 205 that a doctor uses to review drug interaction information for a patient before prescribing any new prescription or non-prescription drugs. When a doctor opens the patient's drug profile window, typically the following information is displayed, each in its own frame or panel—patient profile information in a patient profile frame 207, header information in a header frame or panel 231, drug list information in a drug list frame or panel 211, a warning field in a warning frame or panel 213, and a drug prescription frame or panel 221 having several buttons and a drug interaction detail display area.

The drug list frame or panel 211 is used to display drug list information with drug name, prescription start date, prescription end date, the disease/symptom for which treatment is being offered, and dosage information, for each drug in the list.

The patient's address, age, sex, current weight, etc., are typically displayed in the patient profile frame 207. Some of this information, such as the patient's current weight and age, is retrieved from the most recent patient care records available.

The warning frame or panel 213 is typically used to warn a doctor about potential drug interaction problems or drug side-effects due to the prescription of a new drug, or due to the possible interaction of a new drug about to be prescribed if used in conjunction with another drug previously prescribed to the patient. The warning field frame 213 is also used to warn the doctor about problems with dosage due to recent changes to a patient's weight. It is also used for highlighting warning messages issued by manufacturers or research institutions for drugs being used by the patient, drug mis-correlation alerts for when the doctor prescribes a new drug to a patient to replace an old one in response to changes in the patient's physiological condition, etc.

Typically, before prescribing a new drug for a patient, the doctor selects a drug name from, or enters one into, the drug name combo box 219, and activates a consider drug button 217. In response, the Patient's Drug Profile window 205 retrieves drug information from the prescription network and displays such information in the drug interaction detail panel or frame 221. If the doctor activates a drug interaction button 225, the Patient's Drug Profile window 205 retrieves and displays drug interaction information, taking into consideration some or all prescription and/or non-prescription drugs currently being consumed by the patient. It would also display an interaction summary in the interaction summary area 223.

To facilitate access to information on new or old drugs, the Patient's Drug Profile window 205 also provides a Drug Dictionary button 209 in the header frame or panel 231. By activating this button, a doctor can open up another window in which a dictionary search can be initiated.

Finally, the doctor writes a prescription for the patient by activating the write prescription button 215. In one embodiment, the duration and dosage for the prescription are extracted from external databases and inserted into the prescription. In another embodiment, activating the write prescription button 215 results in the display of another window wherein the doctor selectively enters dosage, usage, warnings, etc., for the prescription.

In one embodiment, the patient's drug profile window 205 displays alternatives for drugs whose interaction profile indicates a conflict with another prescribed drug. In another embodiment, treatment related reports and notes entered by a nurse are selectively displayed at the bottom of the patient profile 207 frame or panel.

Right clicking on any display field brings up the associated information in a pop-up window for better viewing of hidden data or data not properly accommodated in a small or narrow viewing area.

FIG. 3 is a perspective diagram that shows a Patient's Drug Profile window 305 that a health care provider uses to review drug interaction information for the patient before prescribing any new prescription or non-prescription drugs, and to renew/refill/ print out prescriptions.

When a health care provider opens the patient's drug profile window, typically the following information is displayed, each in its own frame or panel—patient profile information in a patient profile frame 307, a new (refill) drug purchase frame or panel 337, header information in a header frame or panel 331, drug list information in a drug list frame or panel 311, a warning field in a warning frame or panel 313, and a drug prescription frame or panel 321 having several buttons and a drug interaction detail display area.

The new (refill) drug purchase frame or panel 337 is used to display a list of drug companies or online drug web sales servers, each with its name and/or logo and price. Banners of online drug sales servers may also be selectively displayed. One of the list of online drug web sales servers may be selected and a fill prescription online button 329 is activated to complete the purchase online. Alternatively, a print prescription button 327 is activated to obtain a hardcopy version of the prescription, which can then be presented in any traditional pharmacy to purchase drugs in the traditional mode. A health care provider may selectively purchase prescription and/or non - prescription drugs on behalf of a patient, when authorized to do so by a patient, a doctor or a health care agency, and deliver them to the patient.

A new prescription box 317 in the drug interaction frame or panel 321 is used to provide the health care provider with an indication that the patient has been prescribed a new prescription by a doctor. The health care provider is thus educated on the potential side-effects of the new prescription. The health care provider is expected to review drug interaction information, and select an alternate drug identified in an alternate prescription box 315.

FIG. 4 is a perspective diagram that shows a Patient's Drug Profile window 405 that a patient uses to review prescription drug information, drug interaction information and drug purchase information. This window is also used by the patient to renew/refill/print out prescriptions. Printed prescriptions may be taken to any traditional pharmacy or hospital to obtain drugs in the traditional mode. This might require the pharmacy to telephone or otherwise contact the doctor or nurse to confirm the authenticity of the prescription.

When a patient opens the patient's drug profile window, typically the following information is displayed, each in its own frame or panel—patient profile information in a patient profile frame 407, a new (refill) drug purchase frame or panel 437, header information in a header frame or panel 431, drug list information in a drug list frame or panel 411, a warning field in a warning frame or panel 413, and a drug prescription frame or panel 421 having several buttons and a drug interaction detail display area.

The new (refill) drug purchase frame or panel 437 is used to display a list of drug companies or online drug web sales servers, each with its name and/or logo and price. Banners of online drug sales servers may also be selectively displayed. One of the list of online drug web sales servers may be selected by the patient, and a fill prescription online button 429 may be activated to complete the purchase online. Alternatively, a print prescription button 427 is activated to obtain a hardcopy version of the prescription, which can then be presented in any traditional pharmacy to purchase drugs in the traditional mode.

A patient may authorize the health care agency to automatically reimburse the online integrated or non-integrated sales server for the drugs delivered to the patient. Alternatively, the patient may pay for drugs purchased using a credit card by entering credit card information in a different window that automatically pops up when the patient activates the fill prescription online button 429.

A new prescription box 417 in the drug interaction frame or panel 421 is used to provide a patient with an indication that the patient has been prescribed a new prescription by a doctor. The patient is thus educated on potential side-effects of the new prescription. The patient may choose to review drug interaction information, and educate himself on alternate drugs identified in an alternate prescription box 415.

In view of the above detailed description of the present invention and associated drawings, other modifications and variations will now become apparent to those skilled in the art. It should also be apparent that such other modifications and variations may be effected without departing from the spirit and scope of the present invention.

What is claimed is:

1. A prescription network comprising:
a patient database that stores patient information;
a web server communicatively coupled to the patient database;
a physician computer, communicatively coupled to the web server, running browser software used by the physician to review the patient information;
at least one physician web page delivered by the web server to the physician computer that presents the patient information for review by the physician, the physician computer responding to input from the physician to generate a new prescription for the patient and to store the new prescription in the patient database as patient information;
a user computer, communicatively coupled to the web server, running browser software used by the user to review the patient information; and
at least one user web page delivered by the web server to the user computer that presents an indication of the new prescription to the user.

2. The prescription network of claim 1 wherein the user is one of a healthcare provider or the patient.

3. The prescription network of claim 1 wherein the user computer is responsive to input from the user to print the new prescription.

4. The prescription network of claim 1 wherein the user computer is responsive to input from the user to order the new prescription online via the at least one user web page.

5. The prescription network of claim 4 wherein the user computer automatically communicates an authorization for reimbursement of the user for the new prescription ordered.

6. The prescription network of claim 1 wherein the at least one physician web page presents a prescription interface that comprises at least one write prescription window, and wherein the write prescription window is manually completed by the physician for generating the new prescription.

7. The prescription network of claim 1 wherein the at least one physician web page presents a prescription interface that comprises at least one write prescription window, and wherein the write prescription window, in response to selection of the new prescription, is automatically completed from information stored in a database.

8. The prescription network of claim 1 wherein the physician computer is responsive to input from the physician for associating a digital signature with the new prescription, and wherein both the new prescription and the associated digital signature are stored in the patient database.

9. The prescription network of claim 1 wherein the physician computer is responsive to the input from the physician for generating and displaying alternate drug information.

10. The prescription network of claim 1 wherein the web server is at a location remote from both the physician computer and the user computer.

11. The prescription network of claim 1 wherein the physician computer is at a location remote from the user computer.

12. The prescription network of claim 1 further comprising a drug analysis engine that evaluates at least the patient information and the new prescription, and generates a warning based on the evaluation for display on at least one of the physician computer and the user computer.

13. The prescription network of claim 12 wherein the patient information comprises current drug usage information, and wherein the drug analysis engine evaluates the drug usage information and the new prescription to generate a drug interaction warning for display on at least one of the physician computer and the user computer.

14. A prescription network comprising:
a patient database that stores patient information;
a web server communicatively coupled to the patient database;
a physician computer, communicatively coupled to the web server, running browser software used by the physician to review the patient information;
at least one physician web page delivered by the web server to the physician computer that presents the patient information for review by the physician, the physician computer responding to input from the physician to generate a new prescription for the patient; and
a drug analysis engine that evaluates the patient information and the new prescription, and generates a warning based on the evaluation for display on the physician computer.

15. The prescription network of claim 14 wherein the patient information comprises current drug usage information, and wherein the drug analysis engine evaluates the drug usage information and the new prescription to generate a drug interaction warning for display on the physician computer.

16. The prescription network of claim 14 wherein the patient information comprises patient physiological information, and wherein the drug analysis engine evaluates the physiological information and the new prescription to generate the warning for display on the physician computer.

17. A prescription system comprising:
a patient database that stores patient information of a patient;
a physician computer communicatively coupled to the patient database, the physician computer responsive to input from a physician to generate a new prescription for the patient; and
a drug analysis engine that evaluates the patient information and the new prescription, and generates a warning based on the evaluation for display on the physician computer.

18. The prescription system of claim 17 wherein the patient information comprises current drug usage information, and wherein the drug analysis engine evaluates the drug usage information and the new prescription to generate a drug interaction warning for display on the physician computer.

19. The prescription system of claim 17 wherein the patient information comprises patient physiological information, and wherein the drug analysis engine evaluates the physiological information and the new prescription to generate the warning for display on the physician computer.

20. A method of providing a warning in a prescription system comprising:
retrieving patient information from a patient database;
receiving an input from a physician computer representative of a new prescription;
evaluating the retrieved patient information and the input; and
displaying a warning on the physician computer.

21. The method of claim 20 wherein the patient information comprises drug usage information, and wherein the warning displayed is a drug interaction warning.

22. A prescription system comprising:
a user interface;
a patient database that stores patient information;
an electronic authentication symbol;
a processor that responds to the user interface by generating a prescription, associating the electronic authentication symbol with the prescription, and storing the prescription and the associated electronic authentication symbol in the patient database.

23. The prescription system of claim 22 wherein the electronic authentication symbol is a digital signature.

24. A method of prescribing drugs comprising:
generating by a first computer a prescription at a first location;
communicating by the first computer the prescription to a server at a second location;
communicating by the server the prescription to a second computer at a third location; and
ordering by the second computer the prescription.

25. The method of claim 24 wherein the ordering comprises printing by the second computer the prescription for hand carry to a pharmacy.

26. The method of claim 24 wherein the ordering comprises communicating by the second computer the prescription to a drug sales server at a fourth location.

27. The method of claim 24 further comprising:
storing, by the server, the prescription in a patient database; and
retrieving, by the server, the prescription from the patient database.

28. The method of claim 24 further comprising:
receiving an input by the first computer; and
associating, in response to the receiving, an electronic authentication symbol with the prescription.

29. The method of claim 28 wherein the electronic authentication symbol is a digital signature.

30. The method of claim 28 further comprising:
storing, by the server, the prescription and the associated electronic authentication symbol in a patient database; and
retrieving, by the server, the prescription and the associated electronic authentication symbol from the patient database.
